(19) United States
(12) Patent Application Publication
(10) Pub. No.: US 2013/0327457 A1
(43) Pub. Date: Dec. 12, 2013

(54) REMOVABLE DECORATIVE COVER FOR A SLOW COOKER

(71) Applicant: Linda Mark, Chesterfield, MO (US)

(72) Inventor: Linda Mark, Chesterfield, MO (US)

(21) Appl. No.: 13/912,757

(22) Filed: Jun. 7, 2013

Related U.S. Application Data
(60) Provisional application No. 61/656,677, filed on Jun. 7, 2012.

(51) Int. Cl. A47J 36/06

(52) U.S. Cl. CPC A47J 36/06
USPC 150/165

(57) ABSTRACT

A cover for use with a slow cooker having a body constructed of a flexible material. The body includes cutout locations for permitting passage there-through of at least the projecting handles and surface located control knobs of the cooker during installation of the body at least about an outer circumference of the cooker. A design indicia is exhibited upon an exterior of the body. The body exhibits an enclosed circular band or an elongated and wrap around band having hook and loop fasteners along opposite extending edges.

### CROSS-REFERENCE TO RELATED APPLICATIONS

The present application claims the benefit of U.S. Provisional Application 611656,677 filed on Jun. 7, 2012, the contents of which are incorporated herein by reference in its entirety.

### FIELD OF THE INVENTION

The present invention discloses a decorative and aesthetically themed cover for installation over a conventional crock pot.

### BACKGROUND OF THE INVENTION

The prior art is documented with examples of coverings, jackets and the like such as which can be used with slow cookers and other articles. Examples of these include the zipper jacket of Haskins D436,805 and D466,373. Also referenced is the carrying case of Jackson D449,441, the pan porter of Mullen D668,916, the insulated pot wrap of Sgrillo D583,629, the crock pot coddler of Schoening 2007/0053618 and the fabric dish and pan holder of Petersen 3,507,312. Of further note is the bowl-shaped neoprene sleeve with side gripping tabs and which is depicted in the Kuhn Rikon “Cook and Serve Coliri” affixing over a standard stainless steel pan and which provides thermal retention properties to the contents of the pan.

### SUMMARY OF THE INVENTION

The present invention is a removable decorative cover for use with slow cookers or crock pots. More specifically, the decorative cover is intended to provide a desired decor or theme associated with any celebrated event (sports team, birthday celebration or the like) as well as any seasonal type theme, and which also provides the user with the ability to update an old cooker or coordinate a newer cooker with the desired aesthetic decor or theme.

The covers can include any type of fabric, silicone, neoprene or other material exhibiting the necessary properties of flex or stretch-ability and which exhibit strategically placed cutout locations which accommodate such controls, handles or cords associated with the slow cooker or crock pot. Additional aspects include the cover being provided as a single piece with no attachment or, alternatively, exhibiting a slit or cut for holding it together.

Additional features include providing a crock pot/slow cooker and sleeve as a combination or kit, as well as providing the attachable covers as an aftermarket accessory for all existing commercial pot or cooker designs. Other aspects include providing the cover in a do-it-yourself kit and which provides indicia or other assistance for guiding a novice user to customize the cover for attachment over the cooker by cutting out the locations for the handles, cord, control dials or the like.

Yet additional non-limiting features include providing a writeable (indicia inscribable and erasable) area upon a surface location of the cover similar to a dry eraser board feature or providing an insert spot or sleeve for receiving an indicia insert relating such as to the identity of the pot or cooker contents. Yet additional aspects include the sleeve or cover being reversible and having design indicia present on both sides.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a decorative cover for use with a slow cooker according to one non-limiting embodiment of the present inventions;

FIG. 2 is a succeeding illustration of the cover similar to that depicted in Fig. I attached over a slow cooker or crock pot and in which both depicted side and lower control knob cutout or access locations are depicted in environmental use with the cooker;

FIG. 3 is a view similar to FIG. 2 of an alternately thematically depicting cover and such as which can be constructed of an alternate mesh flexible material;

FIG. 4 is a further illustration of a non-limiting variant of an attachable cover and in which the one-piece sleeve is reconfigured from the bowl shape depicted in FIG. 1 to an elongated band which is dimensioned to encircle a circumferential midsection of the slow cooker, the band further exhibiting hook and loop inter-engageable fasteners at opposing end extending locations;

FIG. 5 is an illustration depicting the flexible properties of the cover and by which the same is stretched to thereby increase its interior dimension for affixing over the sides of the slow cooker;

FIG. 6 is an illustration of a further variant of cover with design indicia and which is fashioned in the shape of a jersey or T-shirt in which one or more of the cutout portions are refashioned as extending sleeves for accommodating such as the handles of the slow cooker; and

FIG. 7 is an illustration similar to FIG. 6 depicting a further design associated with a jersey variant of a cover.

### DETAILED DESCRIPTION OF THE PREFERRED EMBODIMENTS

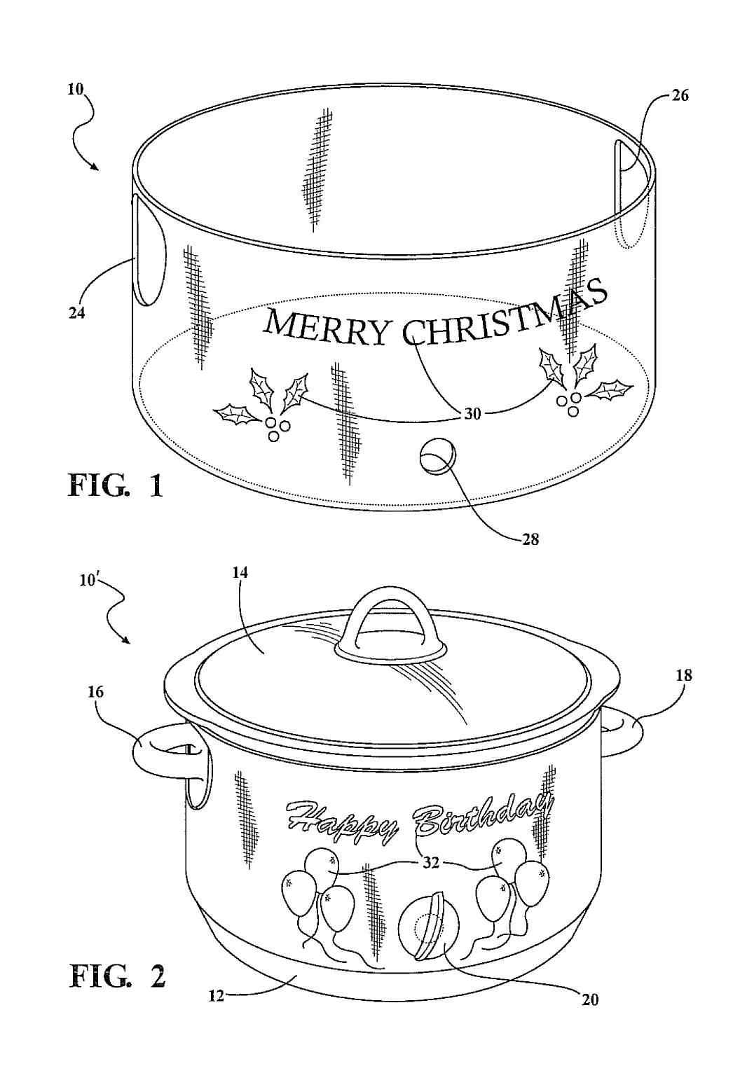

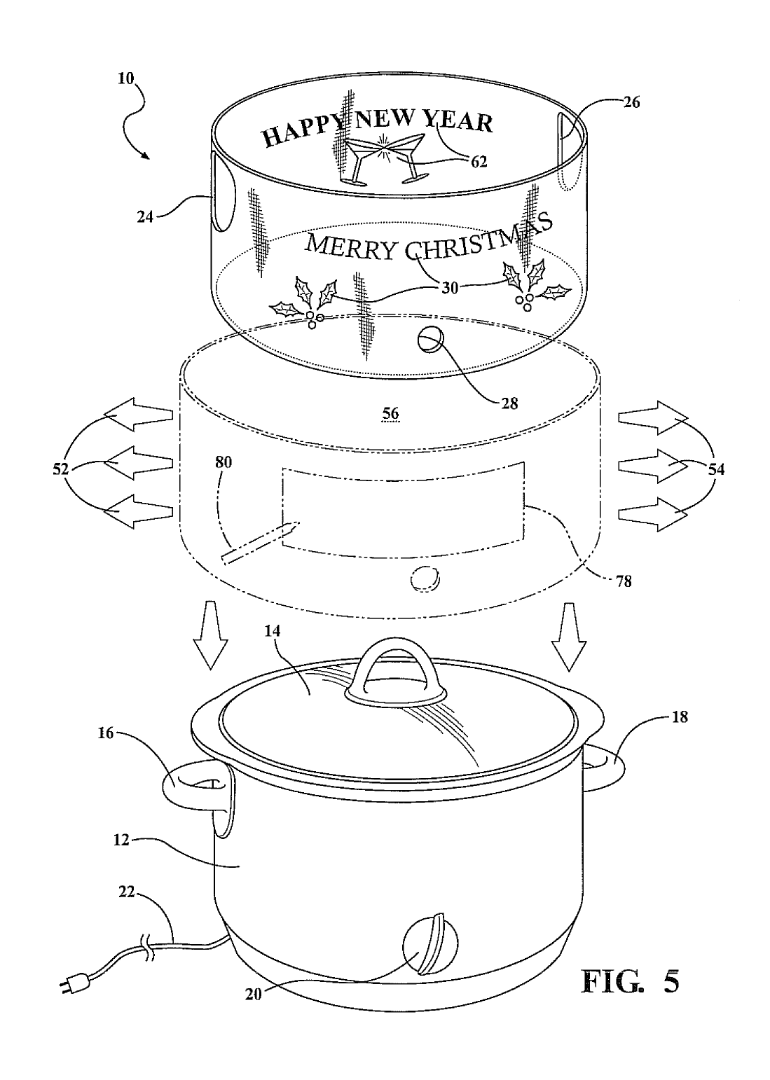

Referring now to FIG. 1, a perspective view is generally shown at 10 of a decorative cover for use with a slow cooker, this further best shown in FIG. 5 and which includes a volume holding body 12 and attachable lid 14. Further shown in FIG. 5 are various surface projecting components associated with the slow cooker, these including side disposed handles 16 and 18, control knob 20 and power cord 22 which must be accommodated by the attachable cover.

As previously described, the decorative cover is intended to provide a desired décor or theme associated with any celebrated event (sports team, birthday celebration or the like) as well as any seasonal type theme, and which also provides the user with the ability to update an old cooker or coordinate a newer cooker with the desired aesthetic decor or theme.

The cover can include any type of fabric, mesh or weave, as well as capable of being constructed of any molded material, such as including a plastic and not limited to silicone, neoprene or the like. In each instance, the material provided exhibits the necessary properties of flex or stretch-ability.

As further shown in FIG. 1, the cover 10 exhibits strategically placed cutout locations such as shown by closed perimeter locations at 24, 26 and 28 which correspond to projecting locations associated with the handles 16 and 18 and control knob 20 (although not shown a similar cutout location can be provided if necessary to accommodate the power cord 22). Also depicted in FIG. 1 is a seasonal decorative indicia design (at 30), with a further such design (at 32) further depicted upon a similar attachable cover 10′ in FIG. 2.

FIG. 2 further depicts the cover 10′ attached over the slow cooker or crock pot in such a fashion in which the handles 16/18 and lower control knob 20 are configured to project through the associated cutout or access locations, again at 24, 26 and 28. As an aside, the knob 20 is typically removable from the body 12 of the slow cooker prior to installation there over of the cover 10′, following which the knob 20 is reattached in the manner shown. As previously described, the material construction of cover is such that it provides a necessary degree of flexural expansion or stretch-ability, and so that an appropriately dimensioned cover can be form-fitted around at least an extending circumference of the slow cooker in the manner best shown in FIG. 2 and further so that the cover maintains a neat appearance once installed over the cooker.

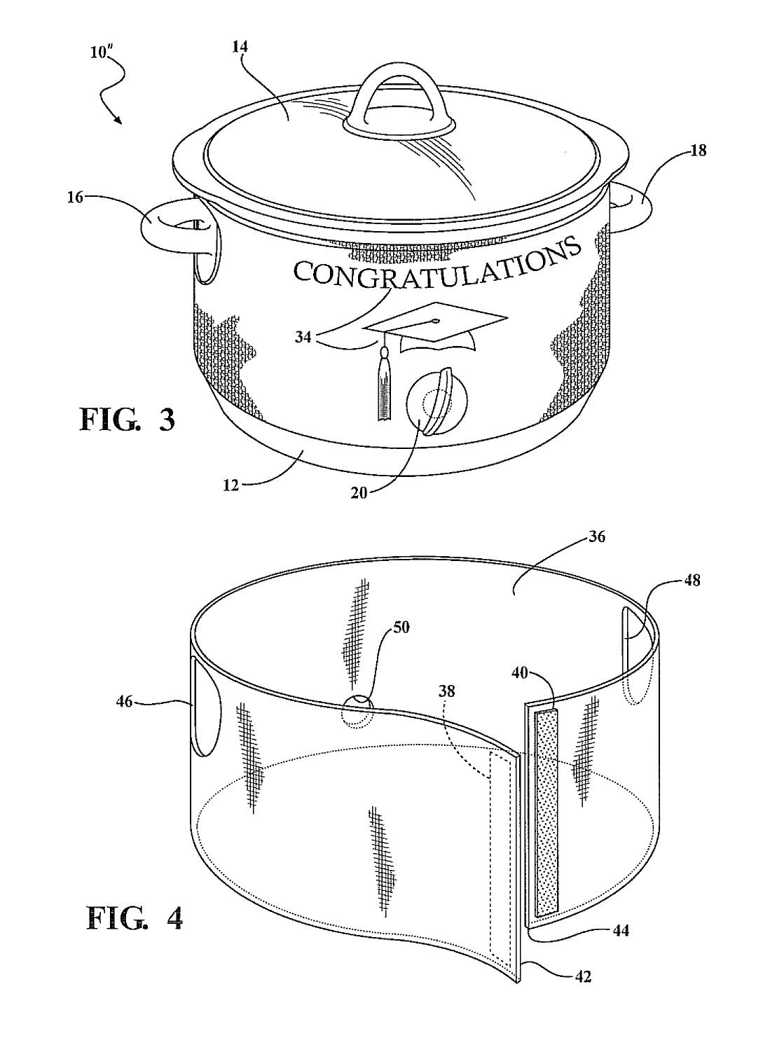

FIG. 3 is a view similar to FIG. 2 of an alternately thematically depicting cover, see at shown at 10″, and such as which can be constructed of an alternate mesh flexible material (and such as compared to FIGS. 1-2 in which the material construction of the covers 10 and 10′ may again include any silicone, neoprene or other suitable molded material). As previously described, the cover exhibits a suitable design indicia 34 which again can be thematically suited to a variety of different celebratory or seasonal events.

FIG. 4 is a further illustration of a non-limiting variant of an attachable cover and in which the one-piece sleeve is reconfigured from the bowl or cylinder shape depicted in FIG. 1 to an elongated band, at 36 which is dimensioned to encircle a circumferential midsection of the slow cooker. As shown, the band further exhibits hook and loop inter-engageable fasteners, see at 38 and 40, extending along opposing end extending locations, further at 42 and 44, of the band. This permits the band to be sized or resized in order to encircle the slow cooker, following which the hook and loop fasteners (or other suitable inter-engaging structure) is employed in order to fasten the cover or wrap thereabout. Additional to the hook and loop fasteners, other types of resecurable and/or adjustable closures can be provided without limitation and can include such as elastic portions, drawstrings, snaps, grommets, and the like.

As previously described, suitable cutout locations are again shown at 46, 48 and 50 in associated with the elongated band 36 for installing around the projecting handle and knob locations of the cooker as previously shown. Additional aspects of the design can include any of the above referenced covers being provided as a single piece with no attachments or, alternatively, can include their exhibiting a slit or cut for holding one or more individual pieces together.

Referring again to FIG. 5, an illustration depicting the flexible properties of the cover 10 are depicted and by which the same is stretched, see opposite directional arrows 52 and 54, to thereby increase its interior dimension (see middle depiction as generally shown at 56) for affixing the cover 10 over the sides of the slow cooker base 12. Although not shown, it is also noted that the cover or sleeve can exhibit any shape not limited to that of a circular closed or elongated band and can also include variants including a partial or fully enclosed bottom, as well as a top or upper edge skirt which can extend partially or substantially over the lid 14 of the slow cooker or crock pot. In the latter instance, an upper edge projecting skirt portion associated with the cover 10 can assist in maintaining the slow cooker lid in place during transport of the cooker (such as to a tailgate or other remote location) and following which the skirt or upper rim portion of the cover can be folded downwardly over itself in order to permit removal of the lid.

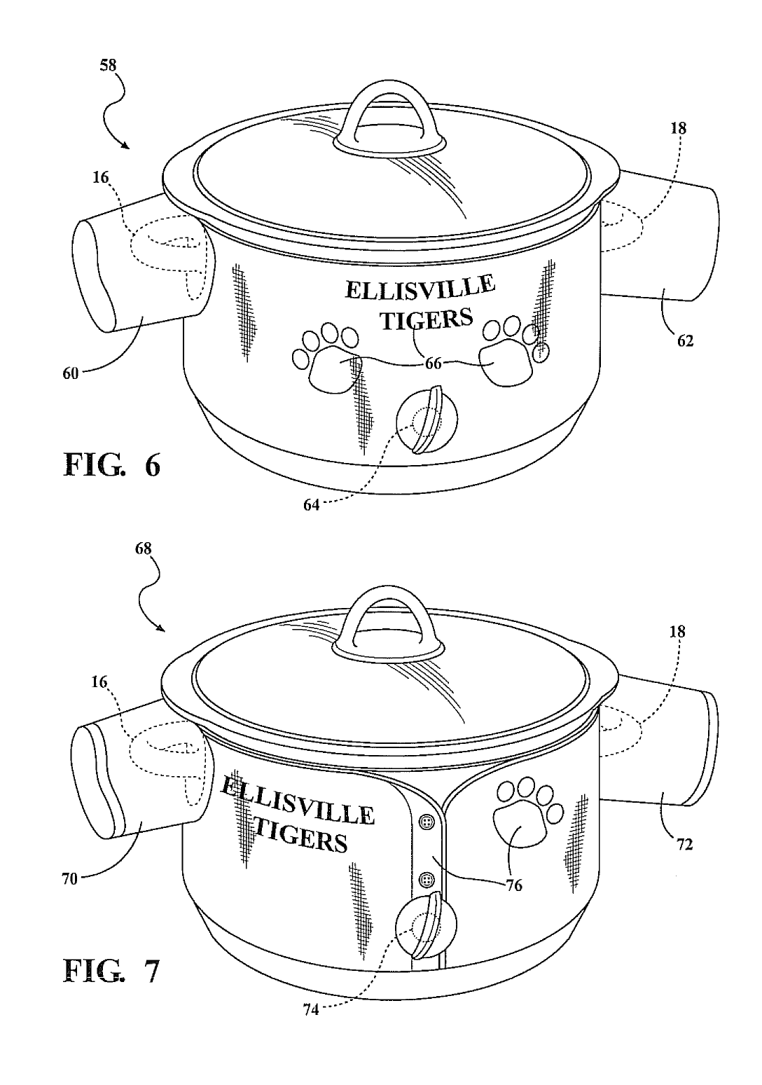

FIG. 6 is an illustration, generally at 58, of a further variant of cover with design indicia and which is fashioned in the shape of a jersey or T-shirt in which one or more of the cutout portions are refashioned as extending sleeves, at 60 and 62 for accommodating such as the handles 16 and 18 of the slow cooker. The sleeves 16 and 18 can be either open or closed at their outer ends however define closed perimeter locations at their connecting base locations with the remaining body of the cover, and as such are cutout portions for purposes of the present disclosure. An additional cutout portion is again illustrated at 64 (similar to that previously depicted at 28 in FIGS. 1 and 5) and which, although hidden, coincides with the projecting of the shaft of the control knob 20. A design indicia is further shown at 66.

Finally, FIG. 7 is an illustration of a further cover, generally at 68 and similar to FIG. 6, with sleeve cutouts 70 and 72, control knob cutout 74, and design indicia 76. The cover 68 incorporates a further selected indicial design 76 associated with a jersey variant of a cover.

In any of the above-variants, it is understood that the heat resistant construction of the material selected can be further assisted or substituted by the incorporation of a flame resistant and heat proof (non-melting) liner, this further assisting in preventing fires. Such a liner can include thermoset plastics which exhibit heat and flame retardant properties while retaining the necessary aspects of stretch-ability and form fitting associated with the covers depicted herein.

The configuration of the covers can be further modified to incorporate either a vertically or horizontally extending closure, the latter instance a horizontal closure providing options for increased adjustability. Reference is again made to the example of the elongated band 36 depicted in FIG. 4 and which could be reconfigured to exhibit hook and loop fasteners along horizontally extending and mating edges. The configuration, type and extending direction of any associated closure is further understood to be determined, at least in part, by the material selected for the cover, as well as the shaping of the slow cooker to be fitted.

Additional features include providing a crock pot/slow cooker and sleeve as a combination or kit, as well as providing the attachable covers as an aftermarket accessory for all existing commercial pot or cooker designs. Other aspects include providing the cover in a do-it-yourself kit and which provides indicia or other assistance for guiding a novice user to customize the cover for attachment over the cooker by cutting out the locations for the handles, cord, control dials or the like. This can include providing the cover initially in pre-incised condition in which the approximate cutout locations of the cover exhibit trace or section lines which are subsequently incised by the user (such as with the use of a box cutter blade or the like), this typically following one or more measurements taken from the slow cooker in order to determine the dimension and location of its handles, control knobs, power cord or the like.

Yet additional non-limiting features include providing a writeable (indicia inscribable and erasable) area upon a surface location of the cover, this similar to a dry eraser board feature. An example of an indicia inscribable location is shown by general example by the surface area representation 78 depicted on the stretched cover in FIG. 5 (such further including a marking instrument such as a wax pen 80). It is understood that a user indicia inscribable location can be provided either additional or alternative to any pre-designed ornamentation or design as described herein.

Another contemplated variation of the cover envisions providing an insert spot or sleeve (also envisioned to include a transparent window secured by stitching or in-molding along two or three sides to the surface of the cover) and within which is received an indicia insert relating such as to the identity of the pot or cooker contents. Yet additional aspects include the sleeve or cover being reversible and having design indicia present on both sides (see reverse side depiction at 62 in FIG. 1).

Although not shown, a yet further variation of the invention can include the provision of a cover with no evident openings or cutout locations for the cooker handles or controls. Rather, a blouse shaped portion can be provided integrated into the cover and which facilitates seating or enclosure of the cooker hardware.

Additional to the aesthetic or design features described above, it is further understood that the attachable covers can also provide any degree of thermal retention or insulation properties to the contents of the slow cooker about which the cover is secured. The material construction of the cover also provides safety for the user, such as helping to avoid bums during transport of particularly hot contents and, additional to the above discussion, can further be constructed of a suitable inflammable (or flame retardant/resistant) mesh or molded material.

The thematic or design aspects of the covers can also include providing in any color matching a decor within the kitchen area, as well as designing the various surface or decorative indicia to represent special events such as birthdays or the like, as well as seasonal periods or holidays including but not limited to Valentine's Day, St. Patrick's Day, Easter, Memorial Day, 4th of July, Labor Day, Halloween, Thanksgiving, Christmas or New Year's. Other thematic designs can include, as non-limiting examples, those associated with professional or collegiate level sports teams, general college or other educational institutional colors or symbols, military related indicia, or the like.

Having described my invention, other and additional preferred embodiments will become apparent to those skilled in the art to which it pertains, and without deviating from the scope of the appended claims.

I claim:

1. A cover for use with a slow cooker, comprising:
a body exhibited by a flexible material;
said body including at least one cutout location which is adapted to overlay and permit passage there through of a projecting location of the cooker during installation of said body at least about an outer circumference of the cooker; and
a design indicia exhibited upon an exterior of said body.

2. The cover as described in claim 1, said body further comprising an enclosed circular band.

3. The cover as described in claim 1, said body further comprising an elongated and wrap around band having hook and loop fasteners along opposite extending edges.

4. The cover as described in claim 1, further comprising said body being constructed of any of a fabric, mesh, weave or molded material.

5. The cover as described in claim 1, further comprising said body being constructed of any of a silicone or neoprene material.

6. The cover as described in claim 1, said at least one cutout location further comprising closed perimeter locations corresponding to projecting locations associated with handles and control knob of the slow cooker.

7. The cover as described in claim 1, further comprising a user indicia inscribable location associated with the exterior of said body.

8. The cover as described in claim 1, further comprising a secondary design indicia exhibited upon an interior of a reversible body.

9. A combination cover and slow cooker, comprising:
said cooker having a base with an attachable lid, said base further exhibiting side projecting handles and at least one knob associated with surface located controls of said cooker;
said cover having a body exhibited by a flexible material, said body including at least one cutout location which is adapted to overlay and permit passage there through of said handles and controls during installation of said body at least about an outer circumference of said base; and
a design indicia exhibited upon an exterior of said attachable body.

10. The invention as described in claim 9, said body further comprising an enclosed circular band.

11. The invention as described in claim 9, said body further comprising an elongated and wrap around band having hook and loop fasteners along opposite extending edges.

12. The invention as described in claim 9, further comprising said body being constructed of any of a fabric, mesh, weave or molded material.

13. The invention as described in claim 9, further comprising said body being constructed of any of a silicone or neoprene material.

14. The invention as described in claim 9, said at least one cutout location further comprising closed perimeter locations corresponding to projecting locations associated with said handles and control knob of said base.

15. The invention as described in claim 9, further comprising a user indicia inscribable location associated with the exterior of said body.

16. The invention as described in claim 9, further comprising a secondary design indicia exhibited upon an interior of a reversible body.

17. A cover for use with a slow cooker, comprising:
a body exhibited by a flexible material fabric constructed of any one of a mesh, weave or molded plastic and exhibiting any of an enclosed circular or wrap around band;
said body including at least one cutout location defined by a closed perimeter and which is adapted to overlay and permit passage there through of a projecting location of the cooker during a form fitting installation of said body at least about an outer circumference of the cooker; and
a design indicia exhibited upon an exterior of said body.

18. The cover as described in claim 17, further comprising a user indicia inscribable location associated with the exterior of said body.

19. The cover as described in claim 17, further comprising a secondary design indicia exhibited upon an interior of a reversible body.

20. The cover as described in claim 17, further comprising said body being constructed of any of a silicone or neoprene material.
